(19) United States
(12) Patent Application Publication
(10) Pub. No.: US 2017/0050700 A1
(43) Pub. Date: Feb. 23, 2017

(54) Multi mode e-bike hub wheel, direct drive, variable overdrive and regenerative braking

(71) Applicant: Joseph Rene Lemmens, APEX, NC (US)

(72) Inventor: Joseph Rene Lemmens, APEX, NC (US)

(21) Appl. No.: 14/756,235

(22) Filed: Aug. 19, 2015

(51) Int. Cl. B62M 6/65; B60L 7/10; B62M 11/16; B62M 6/45

(52) U.S. Cl. CPC B62M 6/65; B62M 6/45; B60L 7/10; B62M 11/16

(57) ABSTRACT

A dual power electric assist hub wheel wherein two power source outputs are combined into a compact planetary gear set with precisely located one-way bearings in a specific configuration which provides:
A first mode, direct drive pedaling
A second mode, motor powered alone with throttle activation
A third mode, dual power drive with variable speed output hub wheel and hand throttle control
A fourth mode, motor and/or pedaling regenerative braking manually activated.

### RELATED APPLICATION

This application claims the benefit of the U.S. Provisional Application Ser. No. 62/070,299, filed on Aug. 20, 2014, which is herein incorporated by reference in its entirety.

### TECHNICAL FIELD

This relates to an electric assist rear hub whose planetary gearing allows the combination of electric motor power and pedaling speed in three power modes: direct drive, motor alone, and variable output speed for the hub wheel; Regenerative braking and complete freewheeling are two more features of this invention.

### BACKGROUND

This field is represented in part in literature and by nearly 100 patents which mostly lack the features needed to provide a complete hybrid drive; many of them are so complex or are built with many highly costly custom parts that any production cost would be prohibitive; several have from three to five sets of gears side by side, making them have a width which could not fit in a normal bike frame.

The prior art in this field showed the following patents:
U.S. Pat. No. 5,242,335 by Michael Kutter, Sep. 7, 1993
U.S. Pat. No. 6,276,475 by Haruhiko Nakansono, Aug. 21, 2001
U.S. Pat. No. 6,974,399 by Chin-Hsiang Lo, Dec. 13, 2005
Pub. US 2006/0037796 A1 by Hans Peter Naegeli, Feb. 23, 2006
Application WO 2011/US 28686 by Jordan Brian, Mar. 16, 2011
Patent CN 102111034A, Jun. 29, 2011
Patent WO 2011162200 A1 by Kiyohiro Ito, Dec. 29, 2011
Pub. NO. 2012/0149517 A1 by Jeong Han Ko and Kyung Phil Kang, Jun. 14, 2012
Application NO. WO 2012/132927 A1 by Kiyohiro Ito, Oct. 4, 2012
Pub. NO. US 2014/008964 A1 by Adriano Zanfei and Fabio Giorgi, Jan. 9, 2014
U.S. Pat. No. 8,536,095 B2 by Kiyohiro Ito, Jan. 28, 2014

### Background of Current E-Bike Drive

The always present goal of cycle and assist e-bike is to permit acceptable pedaling rotational speed under a wide variety of riding conditions; even now most rear hub wheel still use from 5 to 10 ratio at the hub requiring an expensive derailleur and a near 2″ wide cassette or freewheel with 5 to 10 sprockets.

Most e-bike rear hubs are Direct Drive from the motor with the drawback of non-negligible drag from the magnetic and electric interference with when riding without electric assist.

A second group is the geared rear hub motor wheel which is lacking any regenerative capability and still requires the full capability of shifting one or two derailleurs plus controlling the e-bike functions.

A new group is rear hub wheel with wireless control and batteries and controller located inside the wheel hub; here many manufacturers use a single chain or timing belt which limits the bike to mostly flat or urban applications, a few others still carry the multiple sprockets and derailleurs.

### SUMMARY OF THE INVENTION

The present invention is an e-bike rear hub built with mass produced components following a precise configuration allowing several components to be located concentric to each other permitting the use of Direct Drive or Geared Motor combined with one extra planetary set and several one-way bearings, in order to produce a Multi Mode E-BIKE Hub Wheel giving four distinct modes of operation:
Direct Drive in Pedaling
Motor Drive Alone
Variable Speed Overdrive (Both Power)
Regenerative Braking on Demand

This is accomplished with the pedaling power driving a single sprocket or timing pulley at the rear hub; the non-rotating hub shaft is supporting a sleeve where the cyclist rotates the power drive sleeve while a first one-way bearing drives the hub casing providing Direct Drive; on this sleeve, a second one-way bearing drives a sun gear which meshes with the planets whose carrier is fastened to the hub casing in order to propel the rear wheel when the power is provided to the ring gear by the e-bike motor, for either motor drive alone or under Assist Drive and Variable Speed Overdrive; Regenerative Braking is provided by locking the planetary set as a single unit similarly to the Electric Direct Drive rear wheel hub.

### OBJECTS AND ADVANTAGES

It is a foremost object of this invention to provide a rear e-bike wheel hub which is highly efficient and performs similarly to a hybrid car powertrain; either using one of two power sources, human power or electric power, or using the two powers combined together for hill climbing or higher speed riding.

A second object is to permit the user to control the level of power (1-2-3) with one hand at the handle bar near one brake lever and the other hand near the other brake lever to activate the throttle without having to touch the usual console located at the center of the handlebar; the only other control is a push button which activates regenerative braking.

A third object and advantage of this invention is the combination of the current e-bike hub with an extra low cost bicycle planetary and basic small size industrial, or bicycle one-way clutch in a specific configuration to allow the manufacturing of a better highly advanced and competitive e-bike rear hub.

A fourth object and advantage is to allow the use of a cleaner timing belt instead of a chain with the single ratio crank to rear wheel for urban and other uses; a crankset with two gears and front derailleur will provide the necessary low ratio for a cyclist riding in a very hilly area.

### BRIEF DESCRIPTION OF THE DRAWINGS AND PICTURES

This invention's objects, features and advantages will be better understood in consideration of the detailed description of several embodiments illustrated in the drawings and pictures, in which:

FIG. 1 Illustrates a cross-sectional view of a first embodiment of the invention.

FIG. 2 Illustrates a cross-sectional view of a second embodiment of the invention.

FIG. 3 Illustrates a cross-sectional view of a third embodiment of the invention.

FIG. 4-5-6 Show four pictures of the third embodiment as a fabricated prototype. Note: FIG. 4 has anti-rotation clutch.

FIG. 7 Illustrates a cross-sectional view of the first embodiment modified to develop regenerative braking.

FIG. 8-9-10 Show (Prior Art) level 1, 2, and 3 of current control system.

FIG. 11-12 Show prototype of the second embodiment of the invention. Note: FIG. 11 has anti-rotation on the pedal crank

FIG. 13 Illustrates a novel speed pedal assist system (PAS).

FIG. 14-15-16 Show 3 levels of PAS including level 2 and 3 including the FIG. 13 system.

FIG. 17 Shows a 2 or 3 speed crank set which could be used with any of the previous embodiments

### LIST OF NUMERAL REFERENCE

10 electric e-bike rear hub
12 supporting shaft
14 sleeve
16 motor disc
18 electric coils
20 magnetic ring
21 magnetic ring casing
22 supporting flange
24 set of bearings
26 ring gear fastened by press fit
28 sprocket
30 power hub
32 bearing
34 one-way clutch
36 hub casing
38 second one-way clutch
40 sun gear
42 set of planet gears
44 planet holder
46 bearing
48 series of bolts
50 sleeve
52 locking ring
56 keyway
60 feeding cord
62 solenoids
64 set of bolts
66 square edge teeth engaging surface
68 set of plungers
70 set of solenoids
72 set of brushes
74 spring loaded ring
76 group of insulated buttons
110 e-bike rear hub
112 supporting shaft
114 sleeve
118 electric coils
121 ring and supporting flange
122 group of magnets
124 set of bearings
126 second ring gear
128 sprocket
130 power hub
132 set of bearings
134 one-way clutch
136 hub casing
138 one-way clutch
140 sun gear
142 planets
144 planet holder
146 bearing
158 sun gear
160 power cord
164 planetary holder flange
166 one-way clutch
168 set of planet axles
170 set of planets
172 ring gear
174 spacer flange
176 large diameter bearing
178 numerous bolts
180 circle ring
182 second circle ring
210 hybrid rear hub
212 supporting shaft
221 large sprocket
223 sleeve hub
224 set of bearings
226 ring gear
228 sprocket
230 power hub
232 set of bearings
234 one-way clutch
236 hub casing
239 one-way bearing
240 sun gear
242 planet gears
244 planetary holder
246 bearings
262 group of bolt-axles
270 second one-way clutch

### DETAILED DESCRIPTION OF THE INVENTION

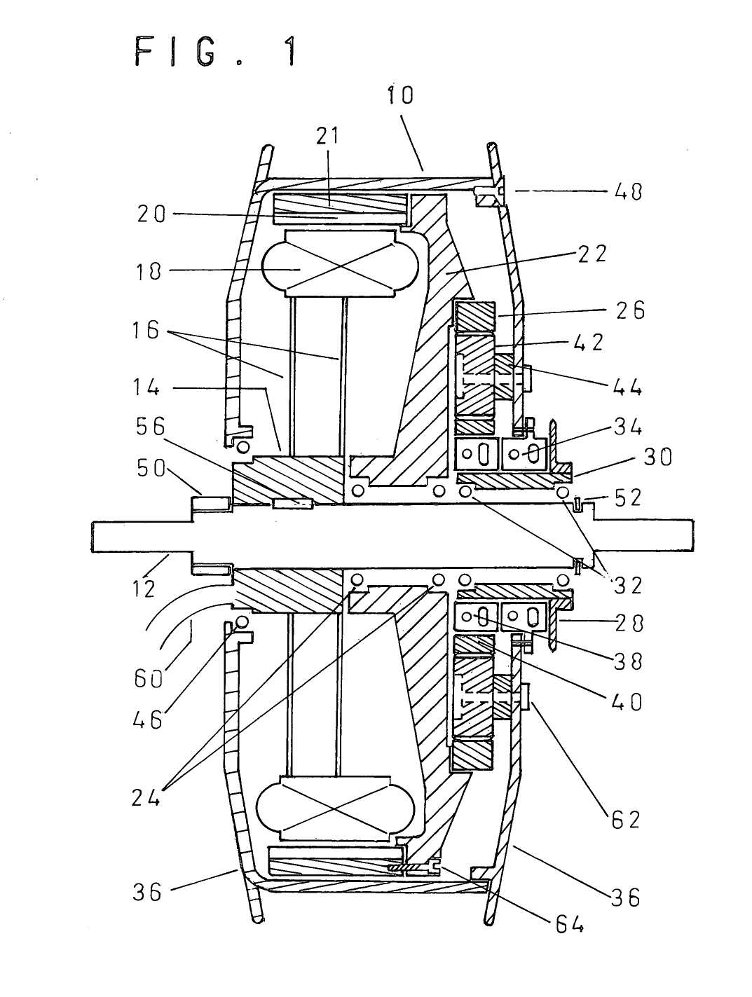

Referring to FIG. 1 which shows a cross-sectional view of an electric e-bike rear hub 10, which includes the first power input, a high torque brush or brushless direct drive motor 20 & 18 fastened around a supporting shaft 12 including a sleeve 14, a motor disc 16 an electric coils 18 which power a magnetic ring 20-21 fastened to a supporting flange 22, which rotates on a set of bearings 24 and transfers its power through a ring gear fastened by press fit 26; the second power input is a sprocket 28 which is directly fastened to a power hub 30, which rotates a bearing 32, which also drives a first one-way clutch 34 which is fastened to and drives a hub casing 36 toward forward motion at a 1:1 ratio when the bicycle is driven in pedaling mode by a set of fastening axle bolts 62; the power hub 30 drives a second one-way clutch 38, linked directly to a sun gear 40 which is free to rotate faster than the power hub sprocket member 28, the main power driving the hub casing 36 is a set of planet gear 42, and a planet holder 44; fastened go the hub casing 36 by the axle bolts 62; a bearing 46 is also supporting the casing on the other side. The hub sleeve 14 is fastened on the supporting shaft 12 by slight press fit and a keyway 56, also the electric power and feedback control wires by a feeding cord 60.

According to the aforementioned structural combination, the novel electric hybrid rear hub allows the cyclist to choose a preferred rotating speed:

1st scenario: one direct drive gear which is comfortable to pedal, example: 60-80 rpm which translates to 15-20 miles per hour. This translates to around 120-200 watts, which an average cyclist can produce via the one-way clutch 32 which drives the hub casing 36 and bicycle wheel. Under pedaling alone the direct drive motor is allowed to rest still because the ring 26 fastened to the motor does not rotate and is compensated by the sun gear 38 which turns freely at 3 times the speed of the wheel for a sun-to-ring ratio of 1:2, at 15 miles per hour or 3 rotations per second, 180 rotations per minute, this is 540 rpm which is much more efficient than rotating the motor at 180 rpm and resulting magnetic interaction.

2nd scenario: when the motor helps the propulsion but the motor speed is equal to the sprocket speed and therefore can assist as low as no power or as high as twice the cyclist power, example: climbing a hill at 15-20 miles per hour with the total power ranging from 300 watts to 900 watts; the motor power load would be 200 to 600 watts, respectively and human pedaling power would be 100 and 300 watts respectively which is under the US Federal limit of 750 for motor power.

3rd scenario: when the motor rotates faster than the pedaling sprocket. Extreme condition is no pedaling and the hub wheel rotates at ⅔ the speed of the motor (this means more torque than a similar motor directly driving the hub wheel combination). Also, this means the electric motor can provide up to 100% of the power or as little as none. The speed relationship of the wheel is a combination of the sun gear and ring gear speed. As example, if on electric alone, 20 miles per hour is the maximum cruising speed, adding pedaling will bring that speed to 30 miles per hour. Again this follows the Federal limit of 20 miles per hour for no pedaling. In summary the motor assist can be from 0% to 100% and the direct speed of 15 miles per hour can be maintained in any situation; then variation from 15 to 30 miles per hour can be achieved by simple motor speed variation.

Under load sharing, with the ring gear turning faster than the human power sprocket, the cyclist power is carried by the sun gear 40 while the motor power is applied to the ring gear 26 and the speed of the output planetary drives the wheel hub at a higher speed than the human sprocket 28 and slower than the motor ring gears; during that time the one-way clutch 34 is running freely.

The hub casing 36 is fastened together by a series of bolts 48, similarly, the ring 21 is fastened to the flange 22 by a set of bolts 64; the axle 12 is completed by a sleeve 50 and on the other end a locking ring 52.

Referring to FIG. 2 which shows a cross-sectional view of a second embodiment of an e-bike rear hub 110 for bicycle which includes a high speed brush or brushless gear motor fastened around a supporting shaft 112 including a sleeve 114, an electric coils 118 which rotate a group of magnets 122 fastened to a ring and supporting flange 121 which rotates on a set of bearings 124 and transfers its power to a sun gear 158; the second power input a sprocket 128 which is directly threaded or fastened to a power hub 130 which rotates on a set of bearings 132, which also drives a first one-way clutch 134 which is fastened to and drives a hub casing 136 toward forward motion at a 1:1 ratio; the power hub 130 also drives a second one-way clutch 138, linked directly to a sun gear 140 which is free to rotate faster than the sprocket member 128, the hub casing 136 is powered with a set of planets 142 planet holder 144 when the bike is driven in electric assist mode; a bearing 146 is also supporting the casing on the other side.

Different than the embodiment is the high speed motor output which is the sun-gear 158 driven directly by a flange disc 121; receiving that power is a planetary holder flange 164 where a one-way clutch 166 is fastened and holds solidly a set of planet axles 168, a set of planets 170 which transmit their rotational torque and speed to a ring gear 171 which is fastened to a large spacer flange 174 which is free rotating on a thin large bearing 176.

The speed and power of the ring gear 172 via the spacer flange 174 to a second ring gear 126 which plays the same role as the ring gear 26 of FIG. 1., first embodiment. Therefore, every component of the output planetary fastened to the hub casing 136 is playing the same role as in FIG. 1.

It is to be noted that the ring gears 172 and 126 are fastened to the spacer flange 174 by numerous bolts 178, also the large diameter bearing 176 is fastened at its inside diameter by a circle ring 180 and at its outer diameter by a second circle ring 182.

It should be noted that the gear motor hub sun gear rotation is always reversed in relation to the bicycle wheel since the planetary and the planets reverse the rotation to the ring gear.

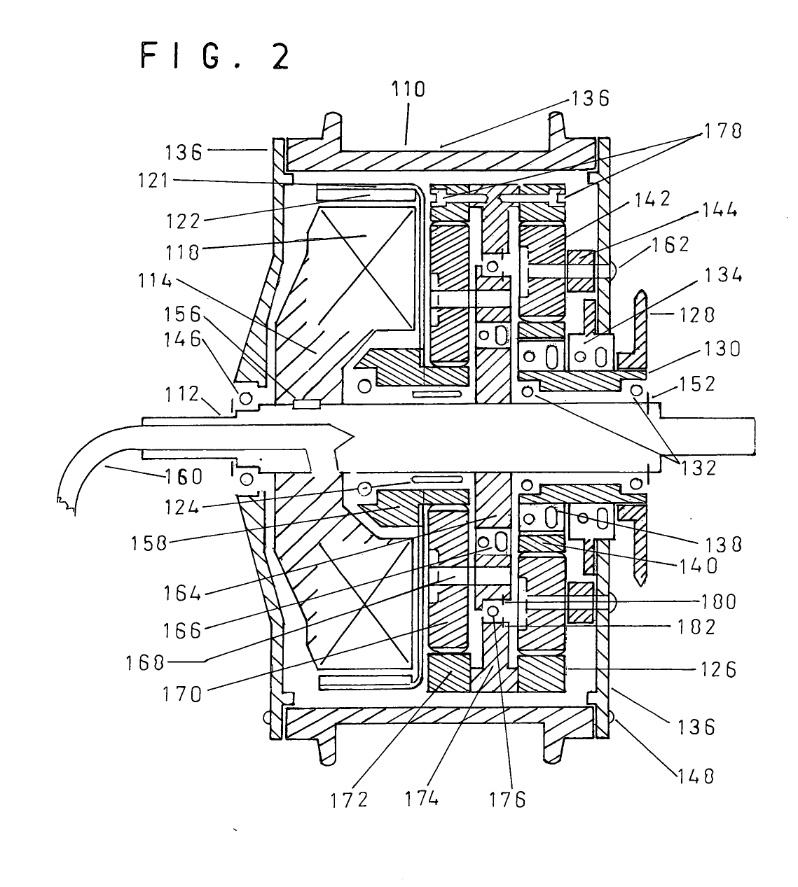

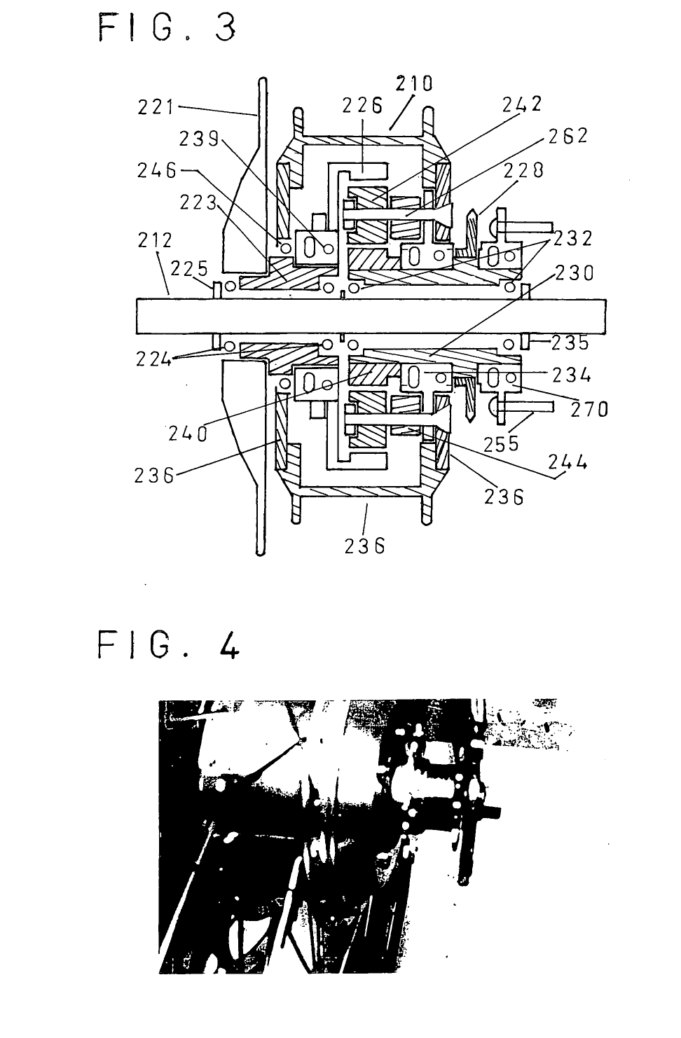

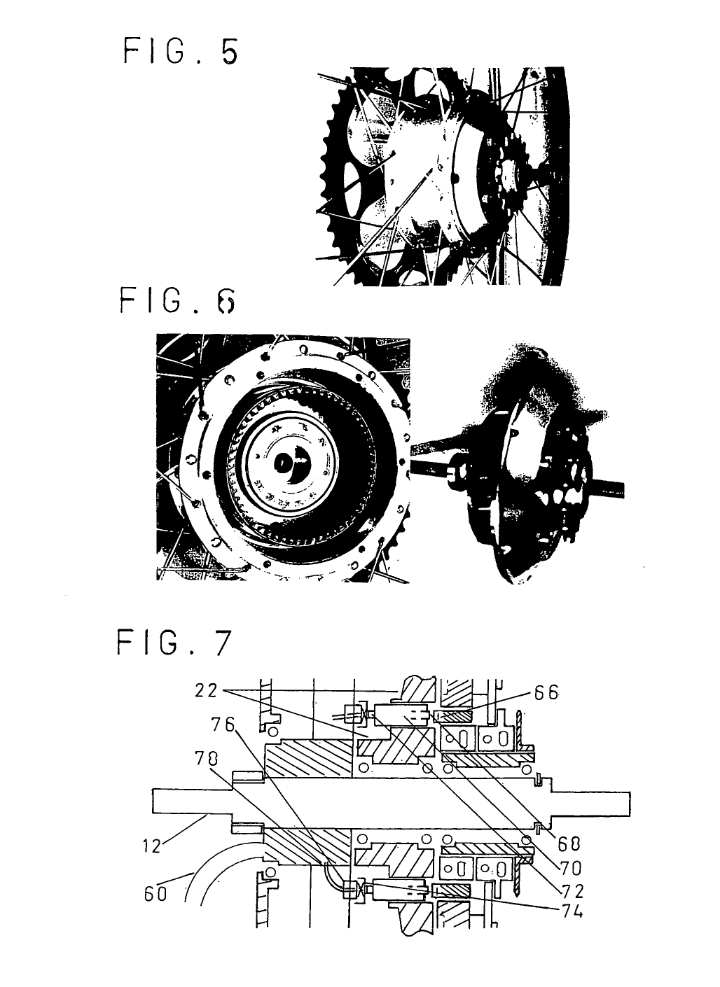

Referring to FIG. 3. which shows a cross-sectional view of a hybrid rear hub 210 which is fastened around a supporting shaft 212 including a large sprocket 221 fastened to a sleeve hub 223 and a ring gear 226; the second power input, a sprocket 228 which is directly fastened to a power hub 230 which rotates on a set of bearings 232 which also drive a first one-way clutch 234 which is fastened to and drives a hub casing 236 at a 1:1 ratio only in forward motion. The power hub 230 also drives a sun gear 240 which is engaged with a group of planet gears 242 which are fastened to the wheel hub casing 236 via a planetary holder 244 and a group of bolt-axles 262.

A one-way bearing 239 allows the power and rotation of an external source via the sprocket 221 to be transferred to the sleeve hub 223 and in a single forward motion to the ring gear 226.

This one-way bearing 239 becomes the key component permitting: either a first scenario propulsion of the hub wheel by only the sprocket 228; or in a second scenario by only the sprocket 221; or in a third scenario by both the sprocket 228 & 221; or in a fourth scenario it permits the hub wheel to freewheel without any motion of any of the two sprockets, in such case the sun gear would not rotate, the planetary holder rotates at the same speed as the wheel and the ring gear would rotate at 1.5 times the speed of the wheel for a ratio of 1:2 between the sun gear/ring gear diameter.

On the power hub 230 is a second one-way clutch 270 which prevents backward rotation of the sprocket 228 when the only power source is the ring gear 226 powered by the large sprockets 221 and permit electric mode without negative torque to the bike user.

Referring to FIGS. 4,5 and 6 which show a PROTOTYPE following the third embodiment FIG. 3.

Referring to FIG. 7 is a central section of FIG. 1 which illustrates the novel system allowing to lock the planetary ring gear supporting flange 22 shown with a square edge teeth engaging surface 66 which allows a set of plungers 68 to engage with.

A set of solenoids 70 are fastened to the flange 22 permitting energization when needed via a group of insulated buttons 76 and a spring loaded ring 74 and a set of brushes 72.

The buttons 76 are fastened to the disc 16 and hub 14 which permit electrical connection with the controller via wire tube 60.

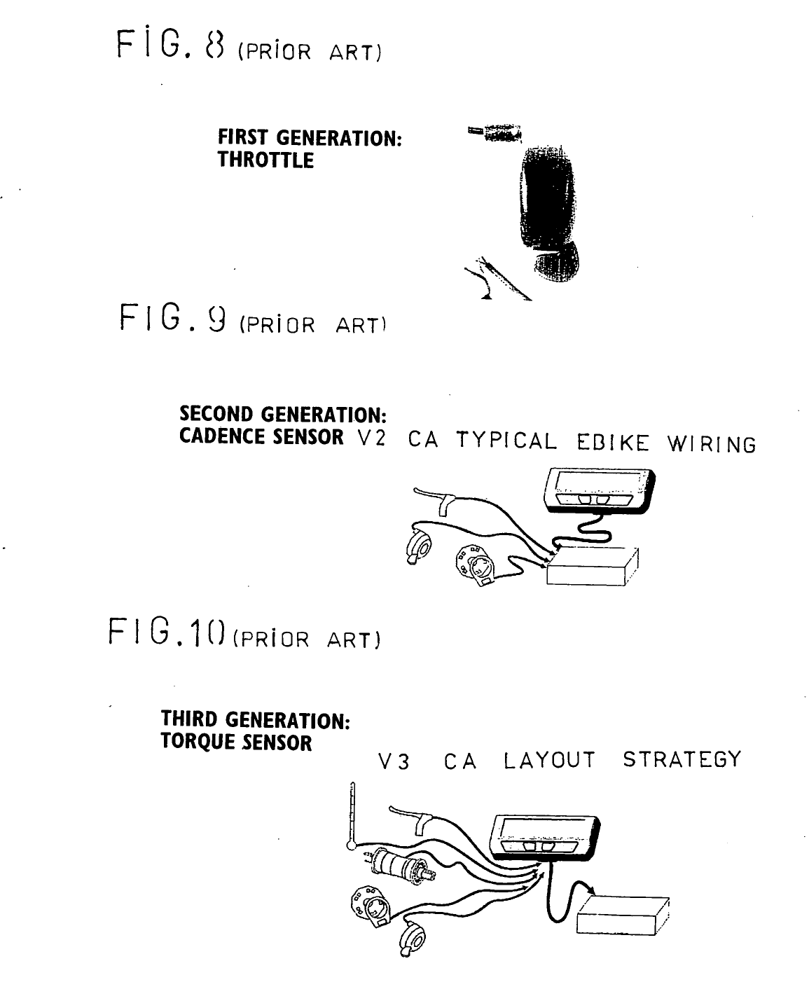

Referring to FIGS. 8, 9 and 10 which show Prior Art of e-bike Pedal Assist System (PAS).

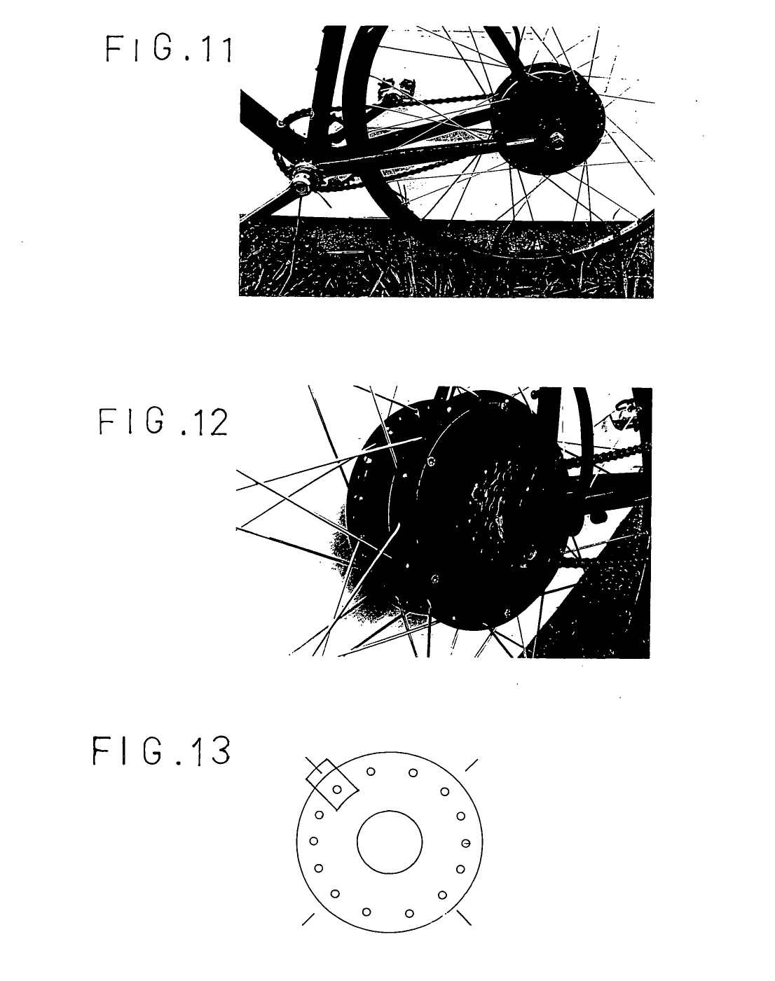

Referring to FIGS. 11 and 12 which show an E-BIKE REAR HUB PROTOTYPE following the second embodiment FIG. 2. On FIG. 11 it is to be noted that a one-way clutch located on the crank arm axle when fastened to the crank arm would prevent reverse rotation of the pedaling allowing the bike to be powered in electric mode alone without requiring the user to counteract the torque transmit by the sun gear 140 and the sprocket 128 and therefore to the crank set via the bike chain shown in the photograph.

Referring to FIG. 13 which shows the novel PAS preferred for the present invention in a manner to improve the pedaling motion where the magnets which are normally equidistant from each other in order for the controller to feel an change of speed in the pedaling motion. Therefore in current e-bike the goal of the magnetic disc and sensor is to keep or to reach the steady speed that the cyclist wants.

In the new sensor shown in FIG. 13, the goal is to have the assist motor to provide more torque during the push down motion of each pedal, and lower torque when the pedaling goes through the over-center or what is called the dead center where the pedaling motion of each leg goes in a more horizontal plane; where in a current assist e-bicycle the pedaling motion is related to the inertia of the bicycle which varies only slightly during the pedaling motion (depending on the speed of the bicycle).

With the new invention when running with the output ring gear rotating faster than the sun gear, the variation of speed of pedaling is competing with the torque of the electric motor, therefore it is necessary to lower the power of the motor during the weak dead center portion of the pedaling. This problem is solved by the new magnet sensor with variation of position of the magnets which instruct the controller to vary its power in relation to the pedaling position.

Even more, if adjusted properly the new speed sensor disc could allow the PAS to permit what is called the dead center pedaling portion to be done faster than the push down section which provides the large portion of the pedaling energy and this gives a more dynamic pedaling motion.

Advanced controller as seen on FIG. 10 (third generation can compensate for as little as 1% inequality between pedaling strength of one leg to the other). Therefore even with a simple magnet sensor speed system it is readily possible to vary the motor output in order to combine harmoniously the cyclist's variation of pedaling torque and the electric motor assist power.

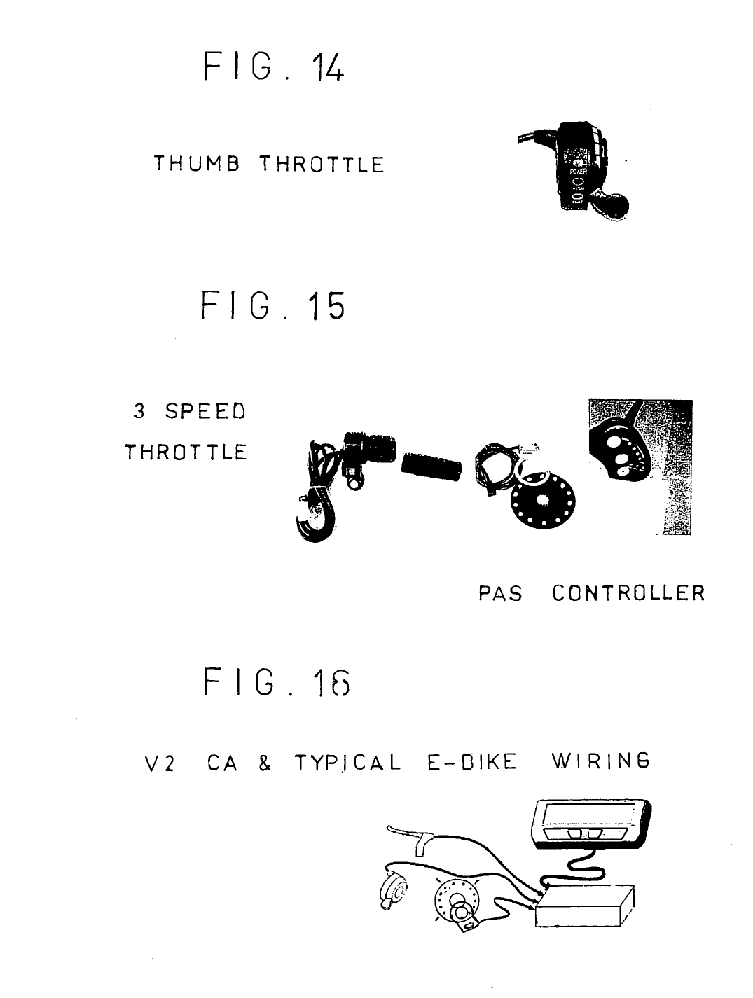

Referring to FIG. 14 which shows a level 1 of control of the new invention and would work with low power hub of around 250-350 watts.

Referring to FIG. 15 which shows the new concept of FIG. 13. PAS speed control which will be advantageous with any power level and permit precise control of power and speed.

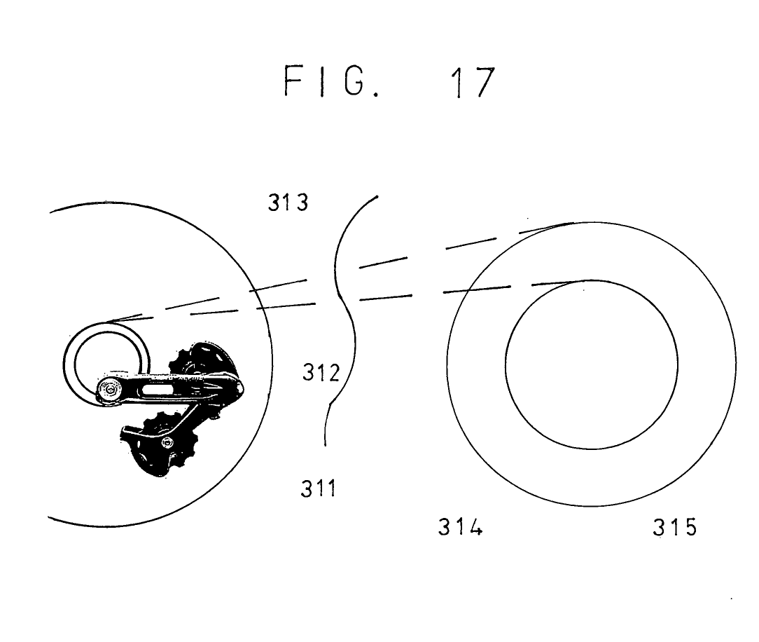

Referring to FIG. 16 which shows the same concept as FIG. 15 combined with a V2 CA control box which gives extra information and data during or after the ride.

Referring to FIG. 17 which shows a two speed front derailleur which provides extra variation of speed for riding on hilly roads. Therefore the rear derailleur is not needed and a single tensioner 311 is used to keep the chain taut and allowing the shifting from larger sprocket 315 to a smaller sprocket 314. At the rear wheel a single small sprocket 312 is transferring the pedaling power to a rear hub wheel 313.

It is to be understood that many mechanical fastenings of the component are done following general mechanical and machinist procedure and therefore it is to be understood that many fastenings which were not shown in the description are either press fit or threaded, and sometimes with lock tight. Sometimes two of the components could be welded together when permitted.

### U.S. Provisional Application Ser. No. 62/070,299 Aug. 20, 2014

From the previous description it is readily apparent that a low cost and compact planetary transmission mechanism can be incorporated into a rear e-bike hub wheel which could be built and appreciated by those skilled in the art. It is to be understood that various changes and modifications may be made without departing from the spirit and scope of the invention.

Therefore, the invention claimed is:

1. An electric assist cycle rear hub comprising:
a hub casing, side plate and axle;
a brush or brushless electric motor;
a planetary gear train;
a pedal powered drive and sleeve;
a control system
Wherein the planetary gear train carrier is fastened to the hub casing, a planet gear set is combining the motor output from a ring gear and a sun gear receiving its power from a first one-way bearing fastened on the drive sleeve, the drive sleeve is also powering directly the hub casing by a second one-way bearing, a third one-way bearing working as anti-reverse rotation at the drive sleeve or the pedal drive sends input information to the control system providing pedaling direct drive and variable speed overdrive to the hub.

2. The electric assist cycle rear hub according to claim 1, wherein the electric motor, planetary gear set, one-way clutch to the casing, the pedal drive and the anti-reverse rotation bearing are located in juxtaposition on the hub axle.

3. The electric assist cycle rear hub according to claim 2 wherein the pedal powered sprocket rotates the sleeve, the first one-way bearing and the hub casing “directly” and lets the motor freewheel via the sun gear one-way bearing.

4. The electric assist cycle rear hub according to claim 2 wherein the motor ring gear powering the planets and planet carrier and hub casing with the sun gear stopped in motor drive alone.

5. The electric assist cycle rear hub according to claim 2 wherein pedal and motor power combine speed and power into the planetary carrier and hub casing when pedal sun gear rotates at or faster than the hub casing.

6. The electric assist cycle rear hub according to claim 2 wherein:
an interactive control system prevents power without pedaling,
a third level of power or plus can be chosen,
a throttle actuator gives precise power control,
a push button activation allows regenerative power by locking the sun gear and therefore the planetary gear driving the motor.

7. The electric assist cycle rear hub comprising:
a hub casing, side plate, and axle;
a high speed brush or brushless electric motor with a planetary speed reducer system including one-way bearing into the carrier;
a second planetary gear train;
a pedal powered drive and sleeve;
a control system
Wherein the second planetary gear train carrier is fastened to the hub casing, a planet gear set is combining the motor low speed output ring gear and a sun gear receiving its power from a first one-way bearing fastened on the drive sleeve, the drive sleeve, the drive sleeve is also powering directly the hub casing by a second one-way bearing, a third one-way bearing working as anti-reverse rotation at the drive sleeve or the pedal drive sends input information to the control system providing pedaling direct drive and variable speed overdrive to the hub.

8. The high speed electric rear hub according to claim 7 wherein the motor, its speed reducer, second planetary gear set, one-way clutch to the casing, the pedal drive sleeve and the anti-reverse rotation bearing are located in juxtaposition on the hub axle.

9. The high speed electric assist rear hub according to claim 8 wherein the pedal powered sprocket rotates the sleeve, the first one-way bearing and the hub casing directly and lets the motor freewheel by its carrier one-way bearing.

10. The high speed electric assist rear hub according to claim 9 wherein its planetary speed reducer ring gear fastened to the second planetary ring gear is powering the planets and planet carrier and hub casing with the sun gear stopped, in motor drive alone.

11. The high speed electric assist rear hub according to claim 9 wherein pedal and motor power combine speed and power into the planetary carrier and hub casing when pedal sun gear rotates at or faster than the hub casing.

12. The electric assist cycle rear hub according to claim 9 wherein:
an interactive control system prevents power without pedaling,
a third level of power or plus can be chosen,
a throttle actuator gives precise power control,
a push button activation allows regenerative power by locking the sun gear and therefore the hub planetary gear driving the motor.

13. A planetary geared cycle real hub comprising:
a hub casing with side plate,
a planetary gear train where the planetary carrier is fastened to the hub casing,
a large sprocket fastened to the ring gear via a one-way bearing,
a small sprocket drives the sun gear and the hub casing via a one-way bearing,
wherein:
the one-way bearing of the ring gear allows freewheeling of the large sprocket,
the one-way bearing of the small sprocket sleeve allows freewheeling of that sprocket,
an anti-reverse rotation bearing allows power alone of the large sprocket,
a control system permits motor speed control providing direct drive and variable speed overdrive to the hub.

14. A planetary geared cycle rear hub according to claim 13 wherein: the large input motor sprocket, one-way bearing to the ring gear, the planetary set, the one-way bearing to the hub casing, the small sprocket, and the anti-reverse one-way bearing are located in juxtaposition on the hub axle.

15. A planetary geared cycle rear hub according to claim 14 wherein: the powered small sprocket rotates the one-way clutch to the hub casing and direct drive is achieved.

16. A planetary geared cycle rear hub according to claim 14 wherein: the motor large sprocket is powering the ring gear, the planetary carrier and the hub casing with the sun gear stopped, one-way clutch in the ring gear allows freewheeling.

17. A planetary geared cycle rear hub according to claim 14 wherein: large and small sprockets combine speed and power into the planetary carrier and hub casing when both sprockets are activated, providing a variable speed of the hub casing.

18. A planetary geared cycle rear hub according to claim 14 wherein:
an interactive speed control system,
a three level power output control,
a precise throttle output control,
a hand control to activate regenerative braking by locking the sun gear and therefore the planetary gear driving the motor.
